(19) United States
(12) Patent Application Publication
(10) Pub. No.: US 2008/0319642 A1
(43) Pub. Date: Dec. 25, 2008

(54) Route Calculation

(76) Inventor: Tod Andrew DeBie, Costa Mesa, CA (US)

Correspondence Address: TOD DEBIE, 2190 PLACENTIA AVE., # C, COSTA MESA, CA, 92627, US

(21) Appl. No.: 11/766,102

(22) Filed: Jun. 21, 2007

(51) Int. Cl. G01C 21/34; G01C 21/00

(52) U.S. Cl. 701/201

(57) ABSTRACT

A method of using historical trip data to determine an optimal route.

### BACKGROUND OF THE INVENTION

1. Field of Invention

This invention generally relates to determining the optimal travel route between two or more points, specifically to determining the optimal travel route for a given trip by using historical and other travel data.

2. Background of the Invention

Navigation devices typically attempt to find the optimal route between two points. The optimal route might be the fastest, the shortest or it might have some other factor that is being optimized for. In addition to the length of any given route, navigation systems may also take into account speed limits, road types, real time traffic, construction areas, accident reports and other factors to calculate the optimal route for a given trip.

There remains a need in the art for improved route calculation to find the optimal route for a given trip.

### SUMMARY

Accordingly, several advantages are provided, according to one or more embodiments, which may include using one or more of the following factors in the determination of an optimal route for a given trip: how long it has previously taken to travel all or part of a given route, where if two or more potential routes have previously been traveled, the system tracked the time taken for each route and can therefore determine which route is optimal.

Another advantage compares the trip time of other people for potential routes to help determine the optimal route.

Another advantage examines route variations where side streets or other route variations are examined to help determine the optimal route.

Another advantage compares the weather, time of day and time of year of previous trips by the user and other people to help determine the optimal route.

Further advantages will become apparent from a consideration of the drawings and ensuing description.

### BRIEF DESCRIPTION OF DRAWINGS

Aspects of this disclosure are illustrated by way of example, and not by way of limitation, in the accompanying drawings, wherein:

FIG. 1 depicts how an embodiment of the invention determines the optimal route for a given trip.

FIG. 2 depicts how an embodiment of the invention copies trip data.

FIG. 3 depicts a car with a navigation system and a storage system.

### DETAILED DESCRIPTION

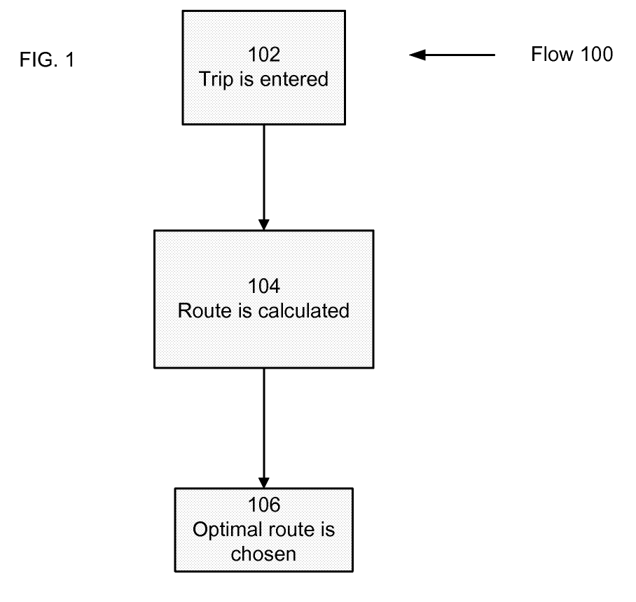

FIG. 1 depicts a flowchart of an exemplary method for determining the optimal route for a given trip. In reference to FIG. 1, an exemplary flow 100 may comprise one or more operations as follows:

In operation 102, a trip is entered into the system. For example, a user may want to go from their home to their office. They might enter the trip via voice command, keyboard entry, favorite recall or equivalents thereof.

In operation 104, potential routes for the trip are calculated. Route calculation may be based on historical trips between the two points and along segments in between. The calculation may also be based on map distance data, speed limit data, traffic data and other factors. Not by way of limitation, but as an example, there might be two possible routes between the two points: route A and route B, where both routes have previously been driven. Historical trip data might show that the average time taken to actually drive route A is shorter than the average time for route B. In other embodiments, more than two routes may be compared.

The differences between route A and B may be small or large. Not by way of limitation, but as an example, in one scenario, the difference between A and B may be taking a small side street for a short distance, while in other scenarios, there may be hundreds of miles of difference between route A and route B. In other scenarios, one route may be a subset of another, or they may be going to or from completely different points where one route may show a segment that is better for the other route than the current choice.

In another embodiment, the historical data might be examined to show which route is fastest for a given time. Not by way of limitation, but as an example, the user may be starting the trip at 6 am. The historical data might show that trips between the two points along route B are faster than route A for trips taken at or around 6 am, while route A may be faster than route B at other times.

In another embodiment, the historical data might be examined to show which route is fastest for a given day. Not by way of limitation, but as an example, the user may be starting the trip on Friday. The historical data might show that trips between the two points along route B are faster than route A for trips taken on Friday, while route A may be faster than route B on other days.

In another embodiment, the historical data might be examined to show which route is fastest for a given time of year. Not by way of limitation, but as an example, the user may be starting the trip in early winter. The historical data might show that trips between the two points along route B are faster than route A for trips taken in early winter, while route A may be faster than route B at other times.

In another embodiment, the historical data might be examined to show which route is fastest for a given type of weather. Not by way of limitation, but as an example, the user may be starting the trip while it is raining hard. The historical data might show that trips between the two points along route B are faster than route A for trips taken while it is raining hard, while route A may be faster than route B in other types of weather.

In another embodiment, traffic data might be accessed to help determine the optimal route. Not by way of limitation, but as an example, traffic data might show that there is an accident on route A that is predicted to clear in a given amount of time. Historical data might show that accidents on route A typically clear in a shorter or longer period. Some embodiments will use the predicted clearance time and other embodiments will use the historical clearance time to determine the overall predicted travel time for route A for comparison to other potential routes.

In another embodiment, historical route data from one or more other drivers might be accessed to help determine the optimal route. Trip data from one or more other drivers both drivers may be copied between the systems, enabling all drivers' historical trip data to be evaluated. Not by way of limitation, but as an example, driver a follows route 1, while driver b follows route 2; where both route 1 and 2 run involve the same or substantially the same beginning and end points. Driver a's route might be faster than driver b's route in some or all circumstances. In some scenarios, driver a's route may be mostly different from driver b's route, while in other examples, driver a's route may differ from driver b's route by a small amount. In some scenarios, driver a's route may be faster than driver b's route in one segment, while driver b's route may be faster than driver a's in another segment where the two better partial routes can be combined into a single superior overall route. After a trip data copy operation, the system would be able to evaluate routes using other driver's data to help determine the optimal route.

Not by way of limitation, but as an example, driver a and b may have different start or end points. Where driver a's route, while not fully encompassing driver b's route, may show a better route for part of driver b's trip. In another scenario, driver b's route may be only a subset of driver a's route where one or the other may be the better route and the system evaluates both to determine which is optimal.

Not by way of limitation, but as an example, driver a's route may have a superior segment that can be used for driver b's route, however to get to the improved segment, driving in areas where no historical data is available may be required. In these scenarios, the system uses map and other data in combination with historical data to determine the optimal route.

In operation 106, the optimal route is selected from operation 104. In some embodiments, this will be the fastest route, in others it will be the shortest route. Other embodiments will optimize for other factors.

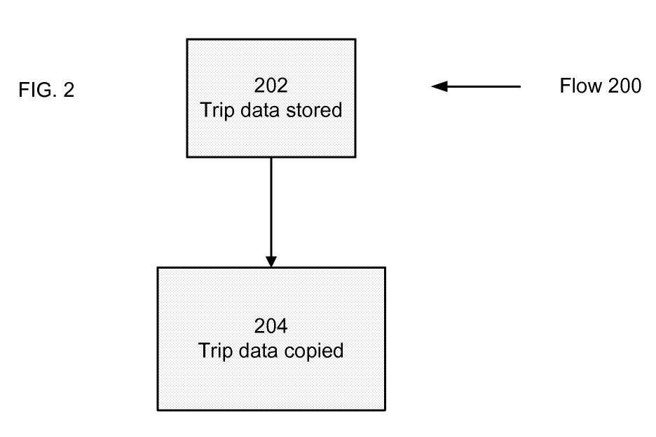

FIG. 2 depicts a flowchart of an exemplary method for copying trip data. In reference to FIG. 2, an exemplary flow 200 may comprise one or more operations as follows:

In operation 202, trip data is stored on a storage device. The storage device may be a hard drive, cd drive, dvd drive, flash memory, ram, or another type of storage device or equivalents thereof. Trip data includes time, date, weather, speed, stops, and time taken to travel between points. These points may be city blocks, street lights, turns, stops, specific distances (100 foot increments, etc.), or other types of landmarks or equivalents thereof. In one embodiment, as trips are taken, trip data is stored on a storage device that can be accessed to allow evaluation of the data for route calculation, as in flow 100.

In some embodiments, the storage device will not be physically near or attached to the navigation system. It may be in another location or it may be a server or equivalents thereof.

In operation 204, trip data is copied between the storage device and a server where trip data from other users is stored. In one embodiment, the copy operation will send trip data from the storage device to the server. In another embodiment, the copy operation will send trip data from the server to the storage device. In another embodiment, trip data will copy from both the server to the storage device and the storage device to the server.

The copy may happen via wireless communication, such as cell phone or WiFi network, via wired network, or via CD, DVD, USB memory or some type of other removable storage device and equivalents thereof.

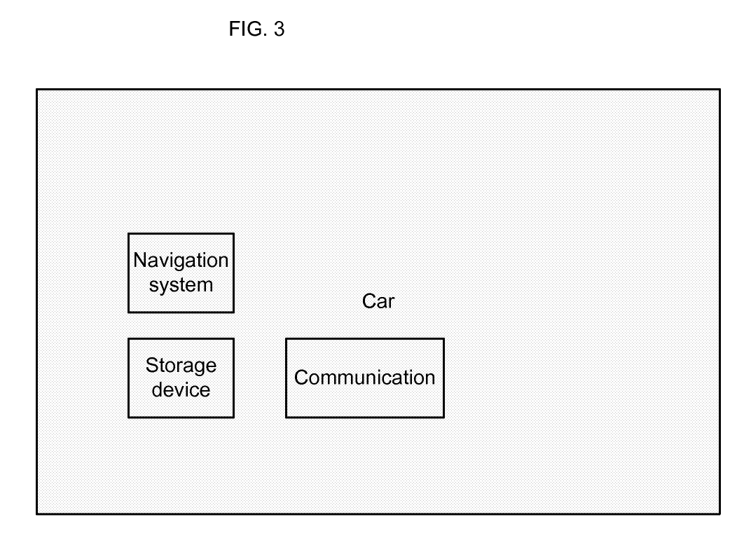

FIG. 3 depicts a car with a navigation system and a storage device. Not by way of limitation, but as an example, the navigation system may be in a car and have a storage device with which to store historical trip data. In other embodiments, the storage device will not be in the car. In other embodiments, the storage device may be a server or an equivalent thereof. A communication system may be present to allow for the copy operation in FIG. 2. Other embodiments may be fully contained in a handheld device. In some embodiments, the navigation system may be based on the Global Positioning System while other embodiments may use inertial navigation or other types of navigation or equivalents thereof.

I claim:

1. A method of determining a route, comprising:
calculating an optimal route based on historical trip data.

2. The method of claim 1, further comprising:
calculating an optimal route based on weather data from historical trip data.

3. The method of claim 1, further comprising:
calculating an optimal route based on the day of the week from historical trip data.

4. The method of claim 1, further comprising:
calculating an optimal route based on the time of day from historical trip data.

5. The method of claim 1, further comprising:
calculating an optimal route based on the time of year from historical trip data.

6. The method of claim 1, further comprising:
calculating an optimal route based on historical trip data from other drivers.

7. The method of claim 1, further comprising:
calculating an optimal route based on accident clearance time from historical trip data

8. The method of claim 1, further comprising:
storing trip data to a storage device wherein the storage device is operatively coupled to a navigation system; and
copying trip data between a storage device wherein the storage device is operatively coupled to a navigation system and a server.

9. A method, comprising:
storing trip data to a storage device wherein the storage device is operatively coupled to a navigation system; and
copying trip data between a storage device wherein the storage device is operatively coupled to a navigation system and a server.

10. The method of claim 9, further comprising:
copying trip data from a storage device wherein the storage device is operatively coupled to a navigation system to a server.

11. The method of claim 9, further comprising:
copying trip data from a server to a storage device wherein the storage device is operatively coupled to a navigation system.

12. The method of claim 9, further comprising:
calculating an optimal route based on historical trip data.

13. The method of claim 9, further comprising:
calculating an optimal route based on historical trip data from other drivers.
